(19) United States
(12) Patent Application Publication
(10) Pub. No.: US 2011/0018796 A1
(43) Pub. Date: Jan. 27, 2011

(54) ELECTRONIC DEVICE

(75) Inventors: Yasuyuki Tobishima, Tsurugashima (JP); Minoru Narazaki, Kumagaya (JP); Tomoaki Nara, Kawagoe (JP); Yuhi Ogawa, Nerima (JP); Yuuki Masuda, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Kawasaki-shi, Kanagawa (JP)

(21) Appl. No.: 12/922,027

(22) PCT Filed: Mar. 12, 2008
(86) PCT No.: PCT/JP2008/054484

§ 371 Date: Sep. 10, 2010

(51) Int. Cl. G06F 3/01

(52) U.S. Cl. 345/156

(57) ABSTRACT

In a car stereo system, when an object such as a hand comes close to a sensing range of a proximity sensor provided near an illumination button while a display section and lights of an operation section that are provided on a front face of the car stereo system are in a state of complete non-lighting, only the light of the illumination button is turned on; if the illumination button is operated within the predetermined period of time, then the display section and the lights of the operation section are turned on; and if the illumination button is not operated within the predetermined period of time, then the light of the illumination button is turned off so that the state of complete non-lighting is entered again.

### TECHNICAL FIELD

The present invention relates to, by way of example, an electronic device that includes a display section for indicating states of devices and an operation section for operating the devices.

### BACKGROUND ART

Conventionally, by way of example in an in-vehicle device such as a car stereo system, a display section for indicating status of devices and an operation section such as a button and a knob for operating the devices are arranged in a front panel of the in-vehicle device. Regions surrounding the buttons and/or knobs of the operation section may be illuminated, or the buttons and knobs as such may be adapted to emit light, so that location of the button and the knob can be readily recognized by a user.

Also, the display section and the operation section may comprise a button for switching between a state of display (in which the display section is turned on and a state of non-display (in which the display section is turned off), and/or between a state of lighting (in which the buttons and knobs of the operation section are allowed to emit light) and a state of non-lighting in which the buttons and knobs of the operation section do not emit light) as required. User's operation of the button allows switching of these operating states.

Methodology for switching between the state of display and the state of non-display of this kind (switching or between the state of lighting and the state of non-lighting) may be, in place of the button, use of a sensor for detection of proximity of an object such as a hand, which is advocated by way of example in an in-vehicle switch illumination device as disclosed in the patent literature PTL 1 and in an automotive television system as disclosed in the patent literature PTL 2, so as to switch between the state of display and the state of non-display (the state of lighting and the state of-non-lighting).

### Citation List

### Patent Literature

PTL 1: Japanese Patent Application Laid-Open Publication No. H8-113098

PTL 2: Japanese Patent Application Laid-Open Publication No. H3-26639

### SUMMARY OF INVENTION

### Technical Problem

In recent years, in the interests of crime prevention in vehicles, there is requirement that the display section and the operation section be only illuminated during operation of these sections while existence of the device cannot be discerned from an outside. In view of such requirement, switching has been conventionally made using the button for switching the above-described the state of display and the state of non-displays (the state of lighting and the state of non-lighting), or the methodology as described in the patent literatures 1 or 2 has been used to detect proximity of the hand or other objects. Such conventional methodology has the following drawbacks.

First, although this drawback may not be found in a case where the state of lighting is switched to the state of non-lighting, if the switching is to be made from the state of non-lighting to the state of lighting, the user who attempts to manually switch these states cannot discern the existence of the switching button because the button as such is placed in the state of non-lighting, which causes trouble in the switching operation. Also, if the device is not fully placed in the state of non-lighting while only the switching button is allowed to emit light except for a case in which the device is operated so that the switching button can be recognized, then this cannot be a perfect crime prevention countermeasure.

Also, in the case of the methodology described in the patent literature 1 or 2, the display section and the operation section may be placed in the state of lighting even in a case where the user does not actually intend to place the device in the state of lighting, including a case where an object accidentally passed over a region near the sensor, which decreases crime prevention performance.

In view of the above-identified problem, an object of the present invention is to provide an electronic device that allows display of the display section and illumination of the operation section by way of example when the user really intends to do so and thus improve the crime prevention performance.

### Solution to Problem

In order to attain the above objective, an electronic device according to claim 1 of the present invention is an electronic device comprising: a display unit adapted to indicate information regarding operation of the electronic device; an operation unit adapted to perform input operation, a first illumination unit adapted to illuminate the operation unit, a second illumination unit configured to illuminate the switching unit; a switching unit configured to switch between display and non-display of the display unit, and adapted to switch between lighting and non-lighting of the first illumination unit; a lighting detection unit configured to detect whether or not the second illumination unit only is turned on when the display unit is in a state of the non-display and the first illumination unit and the second illumination unit are in a state of non-lighting; and a control unit configured to turn on the second illumination unit when it is determined by the lighting detection unit that the second illumination unit is to be turned on.

### BRIEF DESCRIPTION OF DRAWINGS

FIG. 1 is a perspective view illustrating an external appearance of a car stereo system 1 according to a first embodiment of the present invention.

FIG. 2 is a front elevation of the car stereo system of FIG. 1.

FIG. 3 is a block diagram of the car stereo system of FIG. 1.

FIG. 4 is a flowchart of control of states of display and non-display of a display section and states of lighting and non-lighting of buttons and a knob of an operation unit of the car stereo system of FIG. 1.

FIG. 5 is an illustration of the state of complete non-lighting of the display section and the operation section.

FIG. 6 is an illustration of a state where only the illumination button is illuminated.

### REFERENCE SIGNS LIST

1 Car stereo system

3 Display section (display unit)

4 Operation section (operation unit)

4b Illumination button (switching unit)

5 Microcontroller (control unit)

6 Proximity sensor (lighting detection unit)

10 Light (first illumination unit)

11 Light (second illumination unit)

### DESCRIPTION OF EMBODIMENT

The following describes an electronic device according to one embodiment of the present invention. The electronic device of the one embodiment of the present invention includes a control unit that only turns on a second illumination unit when it is detected by a lighting detection unit that a display unit is in a state of non-display and a first illumination unit and the second illumination unit are turned off. Thus, when the display unit is in the state of non-display and the operation unit is turned off, the control unit turns on the second illumination unit so as to illuminate the switching unit only. It is possible to confirm whether or not the user is intentionally attempting the operation. Also, even when the second illumination unit is turned on unintentionally, the range of illumination is small and the device is not readily recognized from an outside, and, as a result, crime prevention performance can be improved when compared with a case where all is turned on.

Also, the lighting detection unit may be configured to operate based on at least one event being selected from the group consisting of: (a) proximity of the object to a predetermined range of the operation unit has been detected; (b) the object contacting or pressing the operation unit has been detected; and (c) a predetermined keyword has been detected via audio input. In this manner, when the illumination for the switching unit is turned on upon the detection of the object that comes close to the predetermined range of the switching unit, the operation will be facilitated by the illumination of the switching unit provided by just the object such as the hand coming closer to the electronic device. When the illumination of the switching unit is provided upon detection of the object coming into contact with or pressing the switching unit, the illumination will not turned on until the switching unit is definitively touched or pressed, which prevents unintentional illumination. When the illumination is provided based on the audio input, the illumination can be turned on without movement of the object such as the hand. Also, combination of these features will further increase the operability of the device.

Also, the switching unit may be configured to be switched on the basis of at least one event being selected from the group consisting of: (a) proximity of the object to a predetermined range of the switching unit has been detected; (b) the object contacting or pressing the switching unit has been detected; and (c) a predetermined keyword has been detected via audio input. With this configuration, operation is facilitated by switching of the state of display and the state of non-display of the display unit in response to detection of the proximity of the object to the predetermined range of the switching unit, which allows the switching to be performed by just moving the object such as the hand close to the device. Also, if the state of display and the state of non-display of the display unit is switched upon detection of the object contacting or pressing the switching unit, the switching will not occur until the switching unit is definitively touched or pressed, which will reduce accidental switching If the state of display and the state of non-display are switched by the audio input and the state of lighting and the state of non-lighting of the illumination unit are switched by the audio input, it is made possible to perform the switching without movement of the object such as the hand. Also, combination of these features will further increase the operability of the device.

Also, the control unit may be configured to turn off the second illumination unit when the switching unit is not operated for a predetermined period of time after turning on of the second illumination unit by the control unit. With this configuration, the second illumination unit is turned off after lapse of the predetermined period of time even when the second illumination device has been accidentally turned on entered. Accordingly, it is made possible to decrease lighting time, and thus the crime prevention performance can be increased.

Also, the control unit may be configured to turn off the display unit, the first illumination unit, and the second illumination unit when the operation unit is not operated for a predetermined period of time after turning on of the display unit, the first illumination unit, and the second illumination unit. With this configuration, it is made possible to fully turn off the display unit and the operation unit when it is not necessary to turn on these units, e.g., when no operation is performed, and thus the crime prevention performance can be increased.

### Exemplary Embodiment

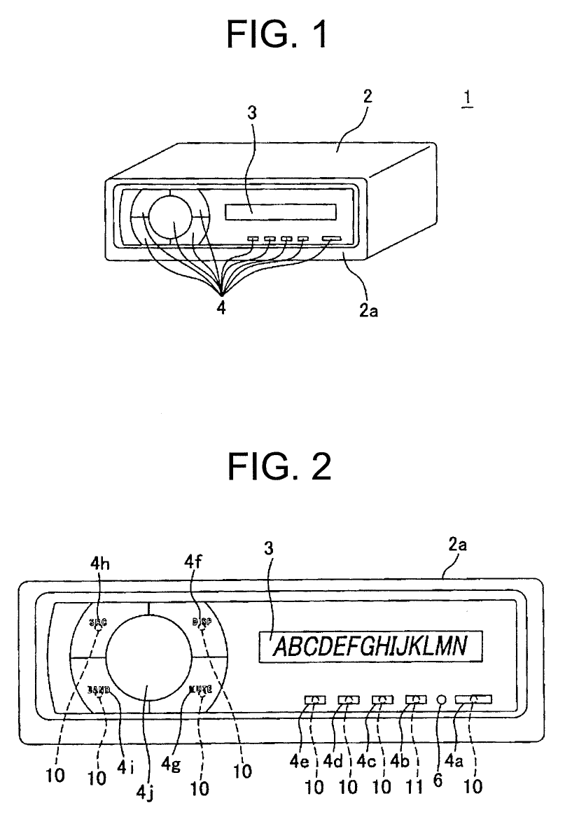

A car stereo system 1 according to one embodiment of the present invention is described with reference to FIGS. 1 to 6.

The car stereo system 1, which may be mounted in an instrument panel in an interior of a vehicle, is a device for viewing and/or listening of radio broadcasting, a CD (compact disc), and a DVD (digital versatile disc).

As shown in FIG. 1 illustrating a perspective view of an external appearance of the car stereo system 1, the car stereo system 1 includes a flat box-shaped case 2 having a front face 2a, and a display section 3 and an operation section 4 that are provided on the front face 2a of the case 2.

The display section 3 serving as the display unit (in the context of the present invention) may comprise a liquid crystal display and/or a fluorescent display tube, and is adapted to indicate operating status of the car stereo system 1.

The operation section 4 serving as the operation unit in the context of the present invention may comprise a button and a knob for use in various operations related to the car stereo system 1.

Regarding the display section 3 and the operation section 4, description is provided in detail with reference to FIG. 2.

Referring to FIG. 2, the front face 2a of the case 2 includes the display section 3 and a plurality of buttons 4a, 4b, 4c, 4d, 4e, 4f, 4g, 4h, 4i, and a knob 4j, which serve as the operation section 4. The button 4b amongst these buttons is referred to as an illumination button. The illumination button 4b is adapted to switch a state of display and a state of non-display of the display section 3, and to switch a state of lighting and a state of non-lighting of lights 10 of the buttons 4a, 4c, 4d, 4e, 4f, 4g, 4h, 4i and the knob 4j, and switch a state of lighting and a state of non-lighting of a light 11 of the illumination button 4b as such. Also, the illumination button 4b functions as the switching unit in the context of the scope of claims.

The display section 3 described in the foregoing may comprise the liquid crystal display or the fluorescent display tube, and the state of display and the state of non-display of the display section 3 can be switched by the illumination button 4b of the operation section 4 (the state of display being a state where display by the display section 3 is turned on and the state of non-display being a state where the display by the display section 3 is turned off). It is also contemplated that, in addition to display and non-display of the display section 3, an external light source may be provided to provide illumination for the display section 3, the light source being adapted to operate in conjunction with the state of display and the state of non-display of the display section 3.

The buttons 4a, 4c, 4d, 4e, 4f, 4g, 4h, and 4i each have inside thereof the light 10 which may be an LED light source. The illumination these buttons is achieved with the light emitted from the light 10 passed to an outside via a transparent portion provided in each button. Likewise, the illumination button 4b includes inside thereof the light 11 which may be an LCD light source, and the illumination of the button is achieved with the light emitted by the light 11 passed to an outside via a transparent portion provided in the button. The knob 4j includes a light provided inside thereof which may be an LED light source which emits light that passes via its peripheral surface. This means that the light 10 corresponds to the first illumination unit in the context of the scope of claims, and the light 11 to the second illumination unit in the context of the scope of claims.

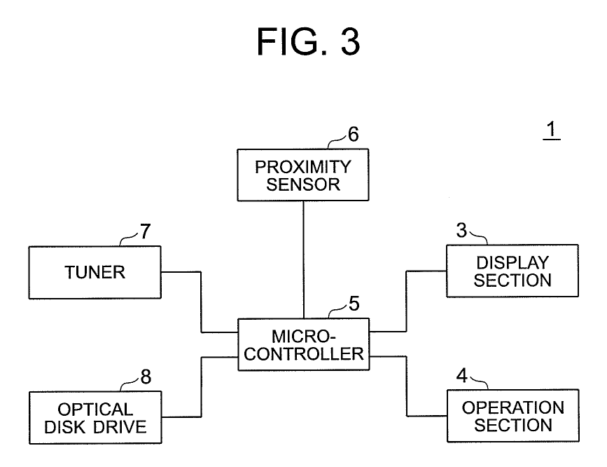

FIG. 3 illustrates a block diagram of the car stereo device 1 shown in FIG. 1.

A microcontroller 5 serving as the control unit (in the context of the present invention) is a microcontroller incorporating a CPU (central processing unit) and a memory unit, and adapted to control overall functionality of the car stereo system 1, and, particularly in this embodiment, the control unit is configured to provide switching between the state of display and the state of non-display of the display section 3 as well as the state of lighting and the state of non-lighting of the lights 10 and 11 of the operation section 4.

A proximity sensor 6 serving as the lighting detection unit (in the context of the present invention) may be an infrared sensor adapted to detect proximity of an object, which may be a hand, to a predetermined range of the illumination button 4b. As shown in FIG. 2, the proximity sensor 6 is provided near the illumination button 4b. More than one proximity sensor 6 may be provided for detection of the proximity of the object to the predetermined range of the front face 2a.

A tuner 7 is a receiving device for receiving radio broadcast. The microcontroller 5 is adapted to turn on and turn off the tuner 7 and switching of broadcasting stations.

An optical disk drive 8 is a device adapted to play back an optical disc such as the CD and the DVD. The microcontroller 5 is adapted to turn on and turn off the optical disk drive and control operation such as playback and stopping playback of the optical disc.

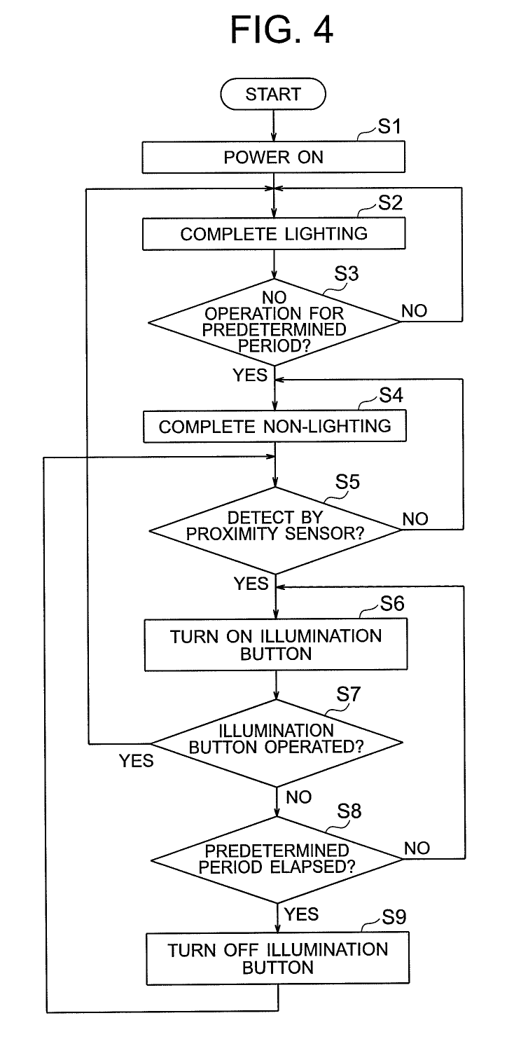

The following describes operational control of the state of display and the state of non-display of the display section 3, and the state of lighting and the state of non-lighting of the light sources such as the buttons and the knob of the operation section 4 in the car stereo system 1 with the above-described configuration, the description being made with reference to the flowchart of FIG. 4. The process depicted by the flowchart of FIG. 4 is performed by the microcontroller 5.

First, in the step S1, the car stereo system 1 is powered on and the process goes to the step S2.

Subsequently, in the step S2, the display section 3 is placed in the state of display, the lights 10, 11 of the operation section 4 are placed in the state of lighting, and the process goes to the step S3. Hereafter, a “state of complete lighting” refers to a state in which the display section 3 is in the state of display and the lights 10, 11 of the operation section 4 are in the state of lighting.

Next, in the step S3, it is judged whether or not the operation section 4 is not operated for a predetermined period of time (no operation state). If the judgment is affirmative (when YES), the process goes to the step S4. If the judgment is negative (when NO), the process goes back to the step S2.

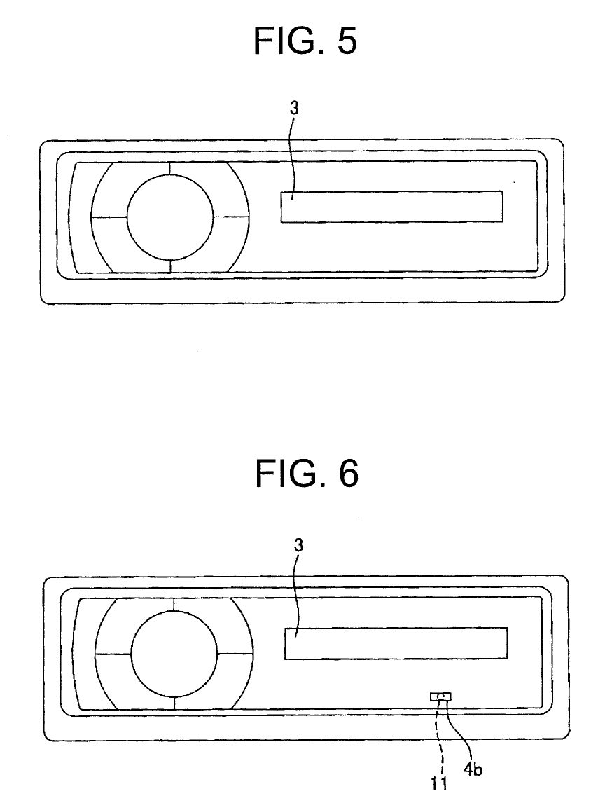

After that, in the step S4, since the operation section 4 is not operated during the predetermined period of time in the step S3, as shown in FIG. 5, the display section 3 is placed in the state of non-display, and the lights 10, 11 of the operation section 4 are placed in the state of non-lighting, and the process goes to the step S5. Hereafter, a “state of complete non-lighting” refers to a state where the display section 3 is placed in the state of non-display and the lights 10, 11 of the operation section 4 are placed in the state of non-lighting.

Subsequently, in the step S5, the proximity sensor 6 judges whether or not the object such as the hand has been detected. If the object has been detected (when YES), the process goes to the step S6. If the object has not been detected (when NO), then the process goes back to the step S4. This means that whether the user's attempt to operate the device is detected in the state of complete non-lighting. Specifically, it is judged whether or not the second illumination unit is to be illuminated in a state where the display unit is in the state of non-display and the first illumination unit and the second illumination unit are in the state of non-lighting. In summary, in this embodiment, detection of the object such as the hand corresponds to detection of whether or not only the second illumination unit is to be illuminated.

Next, in the step S6, as shown in FIG. 6, only the light 11 of the illumination button 4b is illuminated and the process goes to the step S7. In this embodiment, the state of lighting and the state of non-lighting of the lights 10 of the buttons and the knob belonging to the operation section 4 other than the illumination button 4b are controlled all together, while only the light 11 of the illumination button 4b is allowed to be independently controlled.

After that, in the step S7, it is judged whether or not the illumination button 4b has been operated. When the judgment is affirmative, the process goes back to the step S2. When the judgment is negative, then the process goes to the step S8. In this embodiment, the fact that the illumination button 4b has been operated indicates that the illumination button has been touched and pressed by, for example, a finger.

Subsequently, in the step S8, it is judged whether or not a predetermined period of time has elapsed. If the judgment is affirmative, the process goes to the step S9. If the judgment is negative, the process goes back to the step S6. This means that it is judged whether or not operation is attempted during the predetermined period of time following the illumination button 4b being placed in the state of lighting. It should be noted that the predetermined period of time of this step may be the same as the predetermined period of time in the step S3, and also may be specified as the one different from that of the step S3.

Next, in the step S9, the light 11 of the illumination button 4b is placed in the state of non-lighting, and the process goes back to the step S5.

In the car stereo system 1 according to this embodiment, when the object such as the hand comes close to the sensing range of the proximity sensor 6 provided near the illumination button 4b while the display section 3 and the lights 10, 11 of the operation section 4 on the front face 2a are in the state of complete non-lighting, then only the light 11 of the illumination button 4b is turned on. Also, when the illumination button 4 was operated within the predetermined period of time, the display section 3 and the lights 10 of the operation section 4 are turned on. If the illumination button 4b is not operated during the predetermined period of time, the light 11 of the illumination button 4b is turned off so that the state of complete non-lighting is entered again. Accordingly, by illuminating the illumination button 4b only for operating the illumination button 4b as such, it is possible to confirm whether or not the user intentionally attempts to operate the operation section 4. Even when the illumination button 4b only is illuminated unintentionally, the range of illumination will be so small that the device is not readily observed from the outside, so that the crime prevention performance can be increased when compared with a case where all is turned on.

Also, since the light 11 of the illumination button 4b is illuminated upon detection of the object coming in the predetermined range of the illumination button 4b, the operation is facilitated by virtue of the fact that the illumination of the illumination button 4b can be performed by just moving the hand near the illumination button 4b.

Further, since switching between the state of display and the state of non-display of the display section 3 and switching between the state of lighting and the state of non-lighting of the lights 10 of the operation section 4 can be performed upon detection of the object contacting or pressing the illumination button 4b, it is possible to eliminate occurrence of accidental switching, for the switching will not happen until the illumination button 4b is definitively touched or pressed.

Also, the light 11 of the illumination button 4b is turned off by the microcontroller 5 upon lapse of the predetermined period of time after having been turned on, it is possible to turn off the illumination button 4b in a short time even when it was accidentally turned on, and thus the crime prevention performance can be increased.

Further, since the display section 3 and the lights 10, 11 of the operation section 4 are turned off by the microcontroller 5 when they are not operated for the predetermined period of time after having been turned on, it is made possible to turn off the display section 3 and the lights 10, 11 of the operation section 4 when it is not necessary to turn them on, e.g., when no operation is performed, and thus the crime prevention performance can be increased.

Although, the proximity sensor 6 is used in the above-described embodiment, the light 11 of the illumination button 4b may be turned on by a contact sensor such as a capacitance sensor detecting contacting of any of the operation section 4 (or the front face 2a).

Also, the proximity sensor 6 is used in the above-described embodiment. However, an additional separate microphone may be provided to turn on the light 11 of the illumination button 4b in response to a predetermined keyword input via the microphone. In other words, a sound recognition may be employed. Further, two or more features may be employed together, the features being selected from among the proximity sensor 6, the above-described contact sensor, and the sound recognition. This means that the light 11 of the illumination button 4b may be turned on upon detection performed by any of these solutions.

Also, the illumination button 4b may be implemented not as a button but as a switching unit that employs the proximity sensor 6. In other words, it is also contemplated that the state of complete lighting and the state of complete non-lighting may be switched upon detection of the hand coming close to a predetermined range.

Further, the illumination button 4b may be implemented as an audio recognition device in place of the button. Also, combination of features selected from among the button, the proximity sensor 6, and the audio recognition may be a possible solution. This means that the complete lighting state and the state of complete non-lighting may be switched upon detection performed by any of these methods.

According to the above-described embodiment, the following car stereo system 1 can be obtained.

(Addendum 1) A car stereo system 1 comprising: a display section 3 adapted to indicate information regarding operation of the electronic device; an operation section 4 adapted to perform input operation; a light 10 adapted to illuminate the display section 3, a light 11 configured to illuminate the illumination button 4b; a illumination button 4b configured to switch between display and non-display of the display section 3, and adapted to switch between lighting and non-lighting of the light 10; a proximity sensor 6 configured to detect whether or not the light 11 only is turned on when the display section 3 is in a state of the non-display and the light 10 and the light 11 are in a state of non-lighting; and a control unit configured to turn on the light 11 when it is determined by the proximity sensor 6 that the light 11 is turned on.

According to this car stereo system 1, it is possible to confirm whether or not the user is intentionally attempting the operation. Also, even when the light 11, i.e., the illumination button 4b is turned on unintentionally, the range of illumination is so small that the device is not readily recognized from the outside, and, as a result, the crime prevention performance can be improved when compared with the case where all is turned on.

It will be appreciated that the above-described embodiment is an exemplary and particular one of the present invention which is in no way limited to the specifically illustrated form. The present invention may be effectuated with various modifications made within the scope and spirit of the present invention.

1-5. (canceled)

6. An electronic device comprising:
a display unit adapted to indicate information regarding operation of the electronic device;
an operation unit adapted to perform input operation,
a first illumination unit adapted to illuminate the operation unit;
a second illumination unit configured to illuminate the illumination button 4b;
a switching unit configured to switch between a state of display and a state of non-display of the display unit, and adapted to switch between a state of lighting and a state of non-lighting of the first illumination unit;
a lighting detection unit configured to detect whether or not the second illumination unit only is turned on when the display unit is in the state of non-display and the first illumination unit and the second illumination unit are in the state of non-lighting; and
a control unit configured to turn on the second illumination unit when it is determined by the lighting detection unit that the second illumination unit is turned on.

7. The electronic device as set forth in claim 6, wherein the lighting detection unit is configured to operate based on at least one event being selected from the group consisting of: (a) proximity of the object to a predetermined range of the operation unit has been detected; (b) the object contacting or pressing the operation unit has been detected; and (c) a predetermined keyword has been detected via audio input.

8. The electronic device as set forth in claim 6, wherein the switching unit is configured to be switched on the basis of at least one event being selected from the group consisting of: (a) proximity of the object to a predetermined range of the switching unit has been detected; (b) the object contacting or pressing the switching unit has been detected; and (c) a predetermined keyword has been detected via audio input.

9. The electronic device as set forth in claim 6, wherein the control unit is configured to turn off the second illumination unit when the switching unit is not operated for a predetermined period of time after turning on of the second illumination unit by the control unit.

10. The electronic device according to claim 6, wherein the control unit is configured to turn off the display unit, the first illumination unit, and the second illumination unit when the operation unit is not operated for a predetermined period of time after turning on of the display unit, the first illumination unit, and the second illumination unit.
